(19) United States
(12) Patent Application Publication
(10) Pub. No.: US 2006/0235657 A1
(43) Pub. Date: Oct. 19, 2006

(54) System of accumulating component design experience and method thereof

(75) Inventors: Paul Chang, Taipei City (TW); Beniz Wang, Taipei City (TW)

Correspondence Address: BIRCH STEWART KOLASCH & BIRCH, PO BOX 747, FALLS CHURCH, VA, 22040-0747, US

(73) Assignee: INVENTEC CORPORATION

(21) Appl. No.: 11/082,885

(22) Filed: Mar. 18, 2005

(51) Int. Cl. G06F 17/50

(52) U.S. Cl. 703/1

(57) ABSTRACT

The present invention discloses a system of accumulating component design experience, comprising: a user operating interface, a component database, a configuration module of design, and a modification module of design. The present invention further discloses a method of accumulating component design experience, comprising: providing a component design plan, searching and configuring, simulating and modifying via a computer, testing and verifying the mass production, and storing modified data into the component database. The present invention provides the user with an easy way for searching and retrieving a previous design experience without spending as much time as before on a similar design. Thus, not only human resource and cost can be saved via the present invention, but also negligence of engineers can be avoided via the module operation of the present invention.

### BACKGROUND OF THE INVENTION

1. Field of the Invention

The present invention relates to a system of accumulating component design experience and a method thereof, particularly to a system, which is applied to a computer-aided component design and accumulates a component design experience via simulation and modification after verification of the implementation, and a method thereof.

2. Description of the Related Art

Generally speaking, most works of product development are repetitive works. After receiving a design plan, an engineer designs the appearance and structure of a product according to the layout thereof. Once the design has been completed and executed, the data of the design will be filed without arrangement mostly. Even though similar components have been undertaken many times, most engineers will still take as much time as they did before for a new and similar design and draft. The eventual problem is because the past data were not being systematically stored and re-used. The wasting of human resource and cost on repetitive works cyclically is not only increasing the cost of development but also exhausting engineers' energy so that they are unable to make a better design.

Owing to that, it is an important subject to invent a system of accumulating component design experience and a method thereof in order to solve the problem of spending much time for a similar design and draft.

### SUMMARY OF THE INVENTION

In the aforementioned problems of the conventional technology, the primary objective of the present invention is to provide a system of accumulating component design experience and a method thereof. Via various component design experiences, particularly for utilizing computer-aided design, can be accumulated into the system of the present invention and the succeeding component design can be accelerated. Also, the problem of spending much time for a similar design and draft will be solved.

To achieve the aforementioned objective, the present invention discloses a system of accumulating component design experience comprising: a user operating interface, a component database, a configuration module of design, and a modification module of design.

Further, the present invention discloses a method of accumulating component design experience comprising: providing a component design plan, searching and retrieving related data in a component database and undertaking a configuration, simulating and modifying via the computer, testing and verifying the design for mass production, and storing results of the modifying into the component database.

The present invention provides a system of accumulating component design experience and a method thereof, having a variety of advantages that a user can easily retrieve previous design experiences and avoid spending much time for a similar design. Via the module operation of the present invention, not only human resource and cost are saved, but negligence of engineers can also be avoided

Via the attached drawings, the detailed contents and the embodiments of the present invention will be described below in order that the objectives, characteristics and advantages of the present invention can be more easily understood.

### BRIEF DESCRIPTION OF THE DRAWINGS

FIG. 1 is a schematic diagram of system architecture according to one aspect of the present invention.

FIG. 2 is a main flow chart of the operational process of a method of accumulating component design experience according to one aspect of the present invention.

FIG. 3 is a schematic diagram of an embodiment of a system of accumulating component design experience and a method thereof of the present invention.

### DETAILED DESCRIPTION OF PREFERRED EMBODIMENTS OF THE INVENTION

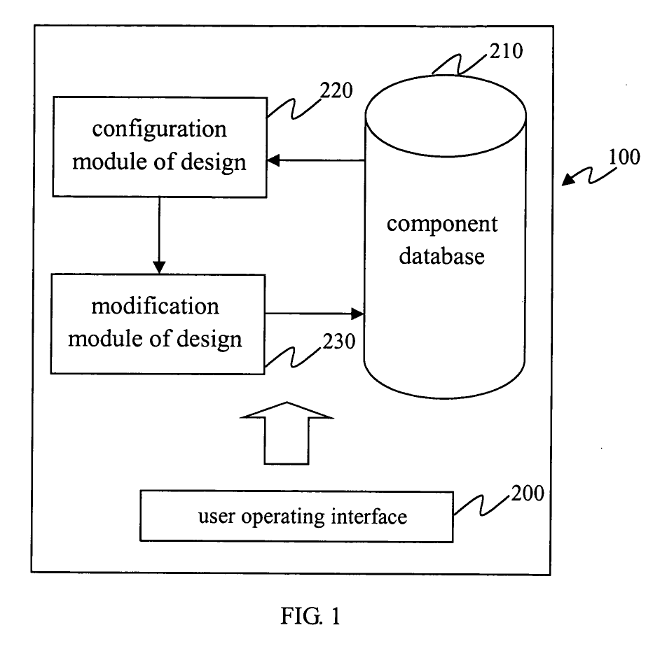

Referring to FIG. 1 a schematic diagram of system architecture according to one aspect of the present invention, a system 100 of the present invention, which accumulates component design experience, comprises:
a user operating interface 200, via which the user operates the system 100;
a component database 210, further including a component data, which comprises the physical data of components, a structure design data, which comprises the virtual data of the structure designs of components, and an appearance data, which comprises the virtual data of the appearance designs of components; a configuration module of design 220, which retrieves related data from the component database 210 according to the need of a design plan in order to undertake a design operation; and
a modification module of design 230, wherein after a variety of design activities including testing and mass production, all of modifications related to the data of structure design and the data of appearance are separately stored into different layers of the same file in the component database 210 in order to accumulate design experience, thus when a similar component is designed next time, the user can retrieve the related data in the component database 210 and accelerate the design activities.

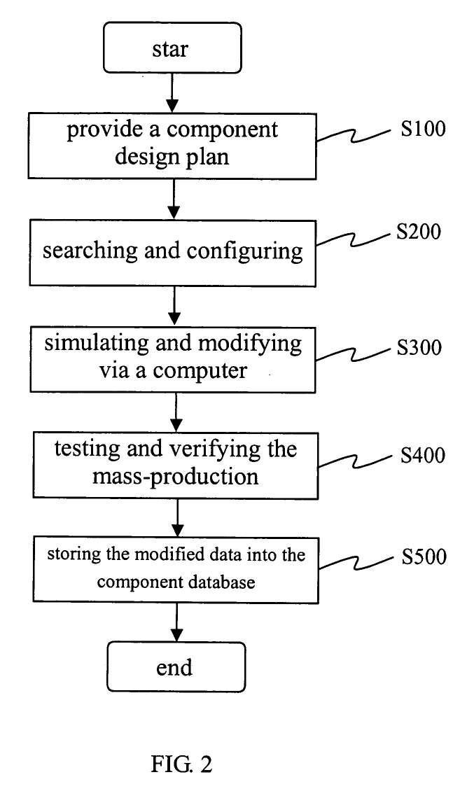

Referring to FIG. 2 a main flow chart of the operational process of a method of accumulating component design experience according to one aspect of the present invention, a method of accumulating component design experience of the present invention comprises:
providing a design plan (step S100), wherein the user undertakes a design activities according to the design plan;
searching and configuring (step S200), wherein if a component appearing in the design plan is not need a completely new design, the user can search and retrieve the related data left before as fundamental articles of this current design activities. After the retrieval of the fundamental articles, a configuration is undertaken;
simulating and modifying via the computer (step S300);
testing and verifying the mass-production (step S400); and
storing the modified data (step S500);
   wherein all of the modifications of design data won't be stored until the result of mass production has been verified. After the verification of the result of mass production has been completed, all of structure and appearance data, which have been modified during the design activities, are stored into different layers of the same files, which correspond to the fundamental articles, in the component database in order to accumulate and provide data for the next time's design activities. If a component of the design plan is a fully new design, the component will be drafted directly, and then the data of the new component will be stored into a new file created for this new component.

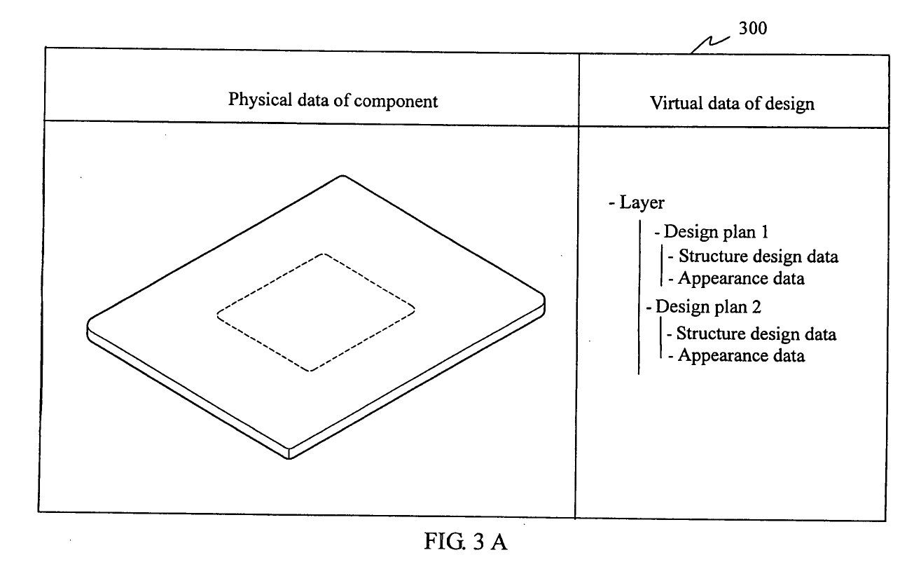

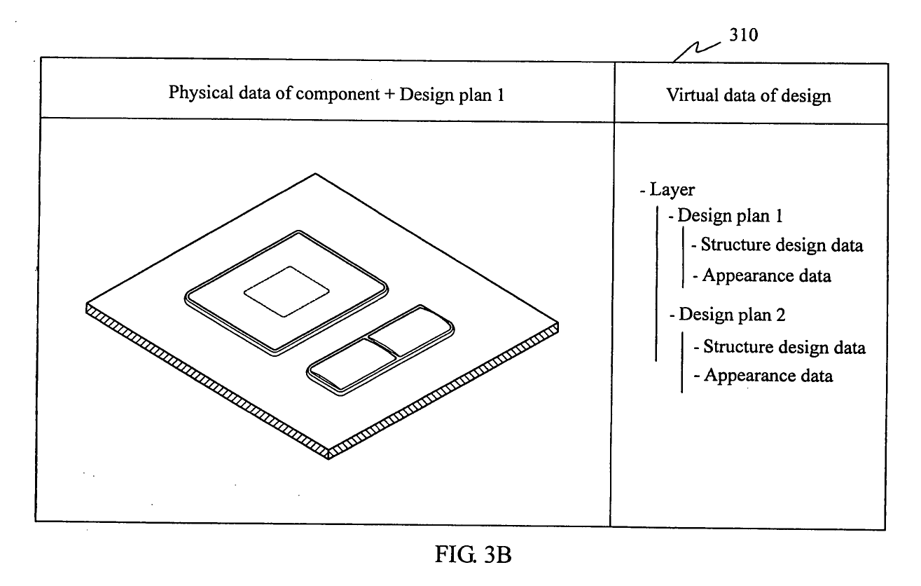

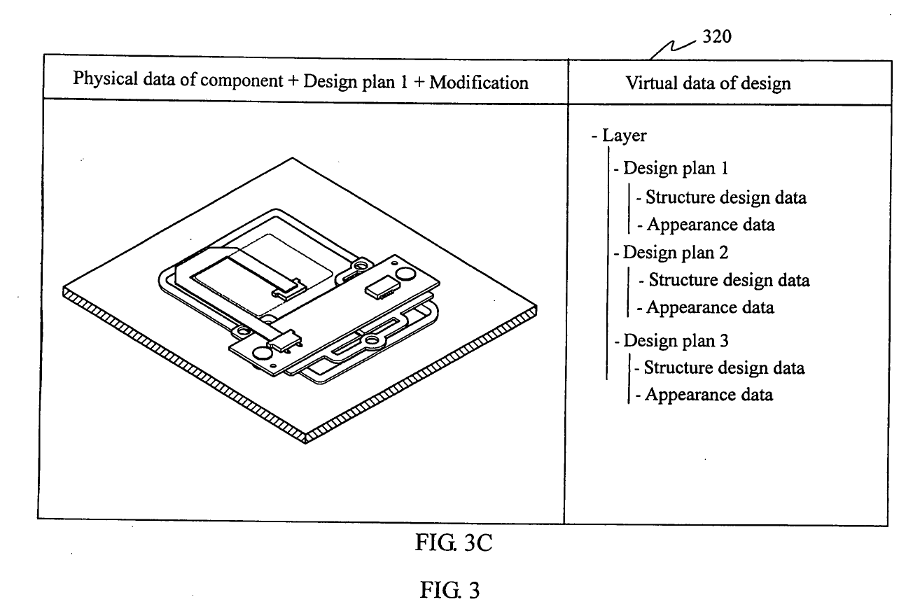

Lastly, an embodiment is utilized to confirm the practicability of the present invention. Referring to FIG. 3 including FIGS. 3A, 3B and 3C, a schematic diagram of an embodiment of a system of accumulating component design experience and a method thereof of the invention. Firstly, according to a design plan, an user utilizes the contents of stored data 300˜310 (as shown in FIGS. 3A and 3B) as a basis of the current design activity to undertake a design and modification via operating interface 200 and selecting performances in schematic screens 300˜320 (as shown in FIGS. 3A to 3C). The modified newer design 320 is verified through testing and mass production. After the verification is completed, the modified data of structure design and appearance are stored into different layers of the original file in the component database 210 in order to accumulate and provide data for the next time's design activities.

The present invention of a system of accumulating component design experience and a method thereof provides a user with an easy way for searching and retrieving previous design experiences without spending as much time as before on a similar design. Thus, not only the human resource and cost can be saved via the present invention, but also negligence can be avoided via the module operation of the present invention. Accordingly, the present invention has an obvious improvement in comparison with the conventional technology.

Those described above are only the preferred embodiments of the present invention, and it is not intended to limit the scope of the present invention. It is to be appreciated by persons skilled in the art that various embodiments and variations can be practiced without departing from the spirit and scope of the present invention, and that the scope of the present invention is dependent on the appended claims, and that any equivalent modification and variation without departing from the spirit and scope of the present invention is to be included within the scope of the appended claims.

What is claimed is:

1. A system of accumulating component design experience, which is utilized in a computer-executable design process, and via which according to a design plan, performs a modification and setting of said design plan, comprising:
a user operating interface;
a component database, wherein a component data, a structure design data, and an appearance data are stored;
a configuration module of design, wherein via said user operating interface, related data are searched and retrieved according to said design plan; and
a modification module of design, wherein via said user operating interface, all modifications of said related data are stored into said component database.

2. The system of accumulating component design experience according to claim 1, wherein said component data is a physical data.

3. The system of accumulating component design experience according to claim 1, wherein said structure design data is a virtual data.

4. The system of accumulating component design experience according to claim 1, wherein said appearance data is a virtual data.

5. The system of accumulating component design experience according to claim 1, wherein said component data, said structure design data, and said appearance design data are in the same file.

6. The system of accumulating component design experience according to claim 1, wherein said modification module of design stores all said modifications of said structure design data and said appearance data into different layers of the same file in said component database.

7. A method of accumulating component design experience, which is utilized in a computer-executable design process and to proceed a setting modification of the design plan according to a design plan, comprising:
providing a component design plan;
searching and configuring; wherein a related data is searched and retrieved from a component database, and a configuration is undertaken;
simulating and modifying via the computer;
testing and verifying the mass-production; and
storing the modified data, wherein all of the results of said modifying are stored into said component database.

8. The method of accumulating component design experience according to claim 7, wherein storing said modified data is to store the results of said modifying of a structure design data and an appearance data into different layers of the same file in said component database.

9. The method of accumulating component design experience according to claim 7, further comprising: creating a new file for a component when said component appearing in said design plan is a fully new design.
